(19) United States
(12) Patent Application Publication
(10) Pub. No.: US 2009/0202399 A1
(43) Pub. Date: Aug. 13, 2009

(54) APPARATUS AND PROCESS FOR PRODUCING A FLUID ACTIVATED BY SINGLET OXYGEN

(76) Inventor: Silko Günzel, Siegburg (DE)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 12/299,058

(22) PCT Filed: Mar. 17, 2007
(86) PCT No.: PCT/EP07/02381

§ 371 Date: Oct. 30, 2008

(30) Foreign Application Priority Data
May 2, 2006 (EP) 06009034.7

(51) Int. Cl. B01J 19/00

(52) U.S. Cl. 422/129

(57) ABSTRACT

Apparatus and process for producing a fluid activated by singlet oxygen, comprising an accommodation vessel which comprises an accommodation chamber which is filled with at least one photosensitizer and with oxygen which can be excited to the singlet state, wherein the accommodation vessel has at least one transparent light incidence wall through which light can come from the outside into the accommodation chamber. The accommodation chamber is completely closed from the outside and the accommodation vessel has at least one transparent activation wall at whose side facing away from the accommodation chamber the fluid to be activated can be activated.

### CROSS-REFERENCE TO RELATED APPLICATIONS

This application claims priority to International Patent Application No. PCT/EP2007/002381 filed Mar. 17, 2007, the disclosures of which are incorporated herein by reference in their entirety, and which claimed priority to European Patent Application No. 06009034.7 filed May 2, 2006, the disclosures of which are incorporated herein by reference in their entirety.

### BACKGROUND OF THE INVENTION

The invention relates to a device for producing a fluid activated by singlet oxygen, which device comprises a receiving vessel which encloses a receiving chamber which is filled with at least one photo sensitizer and with oxygen which can be excited into the singlet state, wherein the receiving vessel comprises at least one transparent light incidence wall through which light can enter the receiving chamber from the outside, wherein the receiving chamber is completely closed towards the outside.

Oxygen is normally in a triplet condition and, by photo-physical means for example, it can be excited into an energy-rich singlet condition. Singlet oxygen has an extremely short life, and, after having been excited into singlet oxygen, it again assumes very quickly the triplet condition. By returning into the triplet condition, there is released energy which, for instance, can be passed on to water which, as a result, is physically changed. Below, this condition is referred to as the activated condition. The associated mechanisms have not been fully clarified, but it has to be assumed that there takes place a change in the structure of the water in which the individual hydrogen molecules are connected to one another by hydrogen bridges. This is indicated by a changed infrared absorption band of activated water.

The actual photo-physical process takes place in a plurality of stages and requires the presence of oxygen. The photo-sensitizer is irradiated with light and absorbs light photons and is elevated into an excited singlet condition or also into an excited triplet condition. If an oxygen molecule whose basic condition is the triplet condition hits the energetically elevated photo-sensitizer, there takes place an exchange of energy, wherein the oxygen molecule is excited into the short-lived singlet condition.

The practical use of activating a fluid, for example, consists in that by breathing in air moistened by activated water, the natural ability of utilizing oxygen is improved. Furthermore, it has been found that the growth of plants can be improved by activated water.

An initially mentioned device is shown in WO 97/43807 A. Via a light wave conductor the light given off by the singlet oxygen is deliberately guided to a treatment area for a biological medium or to a place where a therapeutic measure is carried out.

WO 02/26621 A1, and corresponding U.S. Pat. No. 6,991,831 B2, both of which are incorporated by reference herein, discloses a device for and a process of producing a fluid activated by singlet oxygen. In the receiving chamber there is provided a roughened surface, with the photo sensitizer being polished into the indentations of the finely roughened surface of the photo sensitizer. The receiving vessel comprises an air inlet and an air outlet to be able to guide moist air through the receiving chamber. The air oxygen is thus in direct contact with the photo sensitizer and can be excited by same into the singlet condition. When the air oxygen returns into the triplet condition, the energy released in the process is directly passed on to the water molecules contained in the air. The air can then be used as breathable air. However, during production, care has to be taken to ensure that the photo-sensitizer is firmly connected to a substrate which contains the roughened surface, so that the photo sensitizer cannot reach the air because the materials used as photo sensitizers can be harmful.

### BRIEF SUMMARY OF THE INVENTION

It is the object of the present invention to improve an initially mentioned device in such a way that it can be designed and manufactured more simply and that a defined through-flow of the fluid to be activated is ensured.

In accordance with the invention, the objective is achieved in that the receiving vessel comprises at least one transparent activation wall on whose side facing away from the receiving chamber the fluid to be activated can be activated, and that for the fluid to be activated there is provided a through-flow channel which is arranged on that side of the at least one activation wall which faces away from the receiving chamber, and directly adjoins same.

The oxygen transferred into the singlet condition thus does not form part of the fluid activated by singlet oxygen. Furthermore, it is ensured that the fluid to be activated by singlet oxygen does not come into contact with the photo-sensitizer, so that there is no risk of the photo sensitizer reaching the fluid to be activated. This means that there is no need for firm connections between the photo sensitizer and a substrate. The photo sensitizer can be contained loosely in the receiving chamber or filled loosely into same. The production of the device is thus clearly simpler and more cost-effective.

The light incidence wall and the activation wall can be produced from any transparent material such as glass or plastics.

It is proposed that the light incidence wall simultaneously constitutes the activation wall. The light source is thus on the same side as the fluid to be activated, i.e. on the side of the light incidence and activation wall.

Alternatively it is proposed that the light incidence wall is arranged on a first side of the receiving and the activation wall on a second side of same. The activation wall is preferably arranged opposite the light incidence wall.

The receiving vessel can be cube-shaped for instance or in the form of a sphere. Furthermore, it is proposed that the receiving vessel comprises an outer tube and an inner tube which are arranged inside one another, wherein the receiving chamber is formed between the two tubes and that the outer tube constitutes the light incidence wall and the inner tube the activation wall.

The photo sensitizer is preferably provided in the form of a powder so that it can easily be filled into the receiving chamber. By oscillating the receiving vessel and with the receiving chamber being closed, the photo sensitizer can then be distributed uniformly and in a planar way. The photo sensitizers can be used in the form of colorants which, by the absorption of photons, can be excited to form singlet oxygen. Inter alia, it is possible to use porphyrin and chlorophyll derivatives, synthetic phthalocyanins and naphthalocyanins as well as the thiazine dyes methylen blue and toluiden blue.

To permit light to enter the receiving chamber, it is possible to use a light source which is arranged on that side of the at least one light incidence wall which faces away from the receiving chamber. The light source can, in principle, be a natural light source in the form of the sun or an artificial light source such as a light emitting diode (LED, OLED), a halogen emitter or a laser.

On that side of the transparent wall which faces away from the receiving chamber and which constitutes both the light incidence wall as well as the activation wall, the through-flow channel can be delimited by a transparent channel delimiting wall, wherein to permit light to enter the receiving chamber, at least one light source is arranged on that side of the channel delimiting wall which faces away from the receiving chamber.

Alternatively, it is proposed that on that side of the at least one transparent wall which faces away from the receiving chamber and which constitutes both the light incidence wall and the activation wall, the through-flow channel is delimited by a channel delimiting wall into which there is integrated at least one light source to permit light to enter the receiving chamber.

The fluid to be activated is preferably moist air or water in the liquid phase.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a longitudinal section through a first embodiment of an inventive device with a light incidence wall and a separate activation wall.

FIG. 2 is a longitudinal section through an extended device according to the first embodiment with a through-flow channel.

FIG. 3 is a longitudinal section through a second embodiment of an inventive device with a light incidence wall, which, at the same time, constitutes the activation wall.

FIG. 4 is a longitudinal section through an extended device according to the second embodiment with a through-flow channel.

FIG. 5 is a longitudinal section through a third embodiment of an inventive device with a receiving vessel in the form of a double-walled tube.

FIG. 6 is a cross-section through a device according to FIG. 5 and

FIG. 7 is a longitudinal section through a fourth embodiment of an inventive device with a receiving vessel in the form of a hollow sphere.

### DETAILED DESCRIPTION OF THE INVENTION

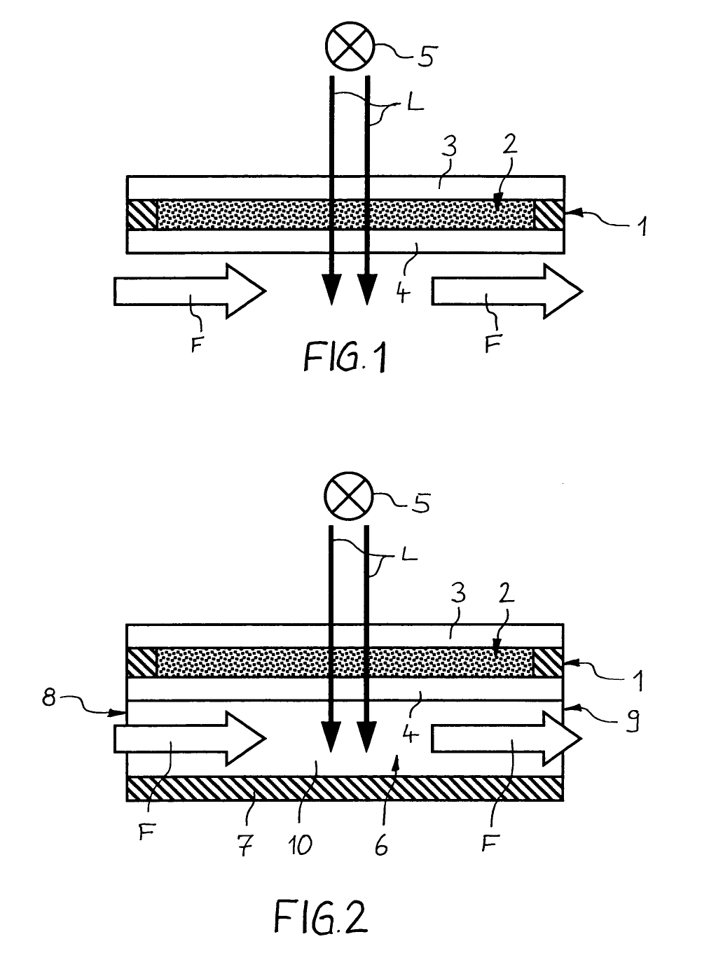

FIG. 1 shows a first embodiment of an inventive device with a receiving vessel 1 which forms and encloses a receiving chamber 2, wherein the receiving chamber 2 is completely closed and sealed towards the outside. In the receiving chamber 2 there is provided a material which serves as a photo sensitizer as well as oxygen or an oxygen-containing gas.

The receiving vessel 1 comprises a transparent light incidence wall 3 through which light (indicated by arrows L) of a light source 5 is able to enter the receiving chamber 2. The light source can be the sun constituting the natural light source or it can be an artificial light source, for example a light emitting diode (LED, OLED), a halogen radiator or a laser etc.

On the side facing away from the light incidence wall 3, the receiving vessel 1 comprises a transparent activation wall 4 which, on its outer side facing away from the receiving chamber 2, the fluid which can be activated (indicated by arrows F) is located and can be activated.

As a result of the light entering the receiving chamber 2 through the light incidence wall, the photo sensitizer is transferred from a basic condition into an energy-enriched condition. Said energy leads to the excitation of the oxygen contained in the receiving chamber 2 into the singlet condition. When the singlet oxygen returns to the triplet condition, there is released energy which is received by the water molecules of the fluid to be activated. In this case, the energy passes through the activation wall 4.

The device according to FIG. 1 can be developed further in that, as shown in FIG. 2, the device comprises a through-flow channel 6 which is arranged on that side of the activation wall which faces away from the receiving chamber 2 and directly adjoins same. The through-flow channel 6 is formed by channel delimiting walls 7, 10, with the activation wall 4 also serving as a channel delimiting wall.

The through-flow channel 6 comprises an inlet aperture 8 and an outlet aperture 9, so that the fluid to be activated is introduced through the inlet aperture 8 into the through-flow channel 6 and guided out of the outlet aperture 9.

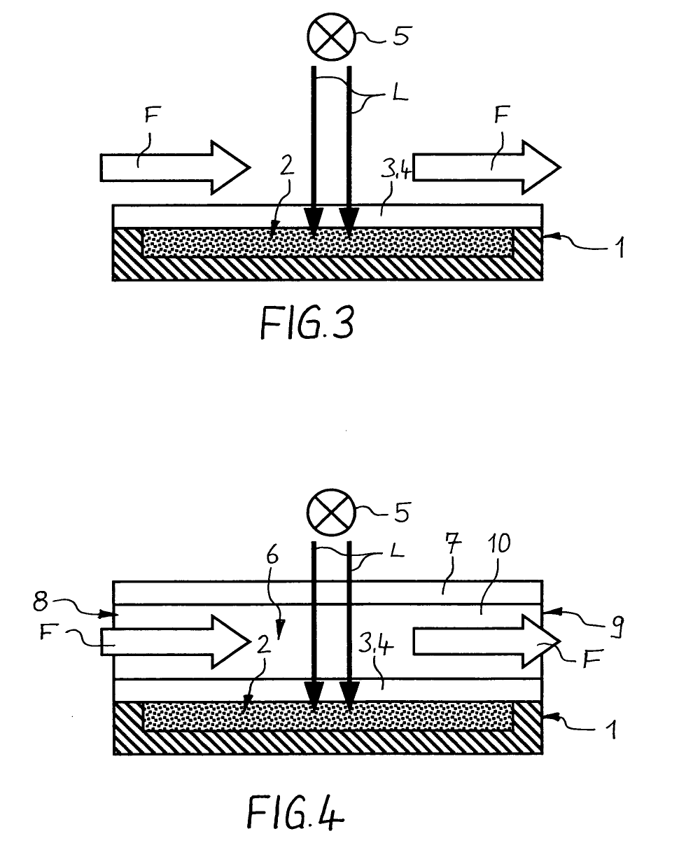

A second embodiment of an inventive device is shown in FIG. 3 wherein any components corresponding to those of FIG. 1 are provided with the same reference numbers.

The second embodiment differs from the first embodiment in that the light incidence wall 3 simultaneously serves as the activation wall 4. The fluid to be activated is thus arranged on the same side as the light source 5.

As shown in FIG. 4, the second embodiment can also be extended by a through-flow channel 6, with one of the channel delimiting walls 7, however, being transparent if the light source 5 is arranged outside the device. The light source 5 is then arranged on that side of the through-flow channel and of the transparent channel delimiting wall 7 which faces away from the receiving vessel 1, so that the light shines through the transparent channel-delimiting wall 7 into the through-flow channel 6 and, furthermore, through the light incidence all and the activation wall 3,4 into the receiving chamber 2. However, the light source can also be integrated into that channel delimiting wall 7 which is arranged opposite the light incidence and activation wall 3, 4. In such a case, the channel delimiting wall does not have to be transparent. There can be provided light sources 5 in the form of LEDs which are inserted into the channel delimiting wall 7.

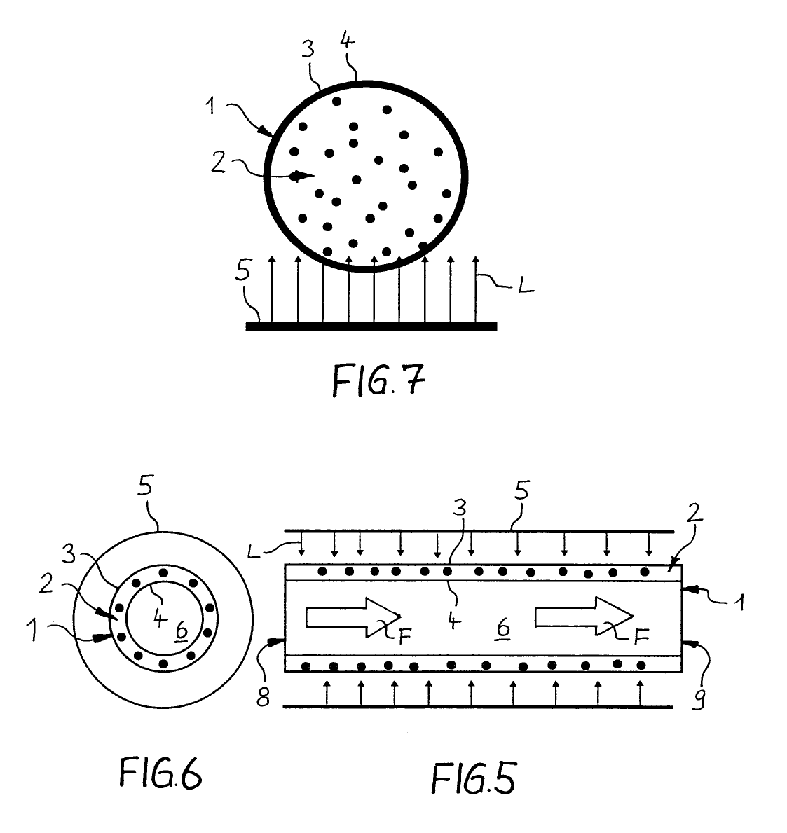

FIGS. 5 and 6 show a third embodiment of an inventive device wherein those components which correspond to the components of FIG. 2 have been provided with the same reference numbers.

The receiving vessel 1 is provided as a double-wall tube with a light inlet wall 3 in the form of an outer tube and an activation wall 4 in the form of an inner wall arranged coaxially relative to the outer wall and inside same. The receiving chamber 2 is formed between said two tubes.

Around the tube-shaped receiving vessel 1 there is arranged a light source 5 which is also tubular and which is arranged coaxially relative to the receiving vessel 1 and around same. Said light source can be a flexible light element in the form of a light emitting diode (LED) or an organic light emitting diode (OLED). However, the light source must not be tubular. It is also possible to provide other light sources 5 such as they were described in connection with the first two embodiments and which illuminate the receiving chamber 3 only on one side or from a limited number of sides.

The tubular activation wall 4, in its inside, forms a through-flow channel 6 for transporting the fluid to be activated.

A fourth embodiment of an inventive device is shown in FIG. 7 wherein those components which correspond to the components of FIG. 1 have been given the same reference numbers.

The receiving vessel 1 is provided in the form of a hollow sphere and completely transparent. In the hollow spherical receiving vessel 1 there is formed a receiving chamber 2. The receiving vessel 1 is illuminated from the outside, with a wall portion of the receiving vessel 1, which wall portion faces the light source 5, constituting the light incidence wall 3. The entire enveloping hollow spherical wall of the receiving vessel 1 can serve as the activation wall 4 depending on where the fluid to be activated is located around the receiving vessel 1.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

### LIST OF REFERENCE NUMBERS

1 receiving vessel
2 receiving chamber
3 light incidence wall
4 activation wall
5 light source
6 through-flow channel
7 channel delimiting wall
8 inlet aperture
9 outlet aperture
10 channel delimiting wall
L light
F fluid

1. A device for producing a fluid activated by singlet oxygen, comprising a receiving vessel which encloses a receiving chamber which is filled with at least one photo sensitizer and with oxygen which can be excited into the singlet state,
wherein the receiving vessel comprises at least one transparent light incidence wall through which light can enter the receiving chamber from the outside,
wherein the receiving chamber is completely closed towards the outside,
wherein the receiving vessel comprises at least one transparent activation wall on whose side facing away from the receiving chamber the fluid to be activated can be activated, and
that for the fluid to be activated there is provided a through-flow channel which is arranged, on that side of the at least one activation wall which faces away from the receiving chamber and directly adjoins same.

2. A device according to claim 1,
wherein the light incidence wall at the same time constitutes the activation wall.

3. A device according to claim 1,
wherein on a first side of the receiving chamber there is provided the light incidence wall and on a second side the activation wall.

4. A device according to claim 1,
wherein the receiving vessel is cube-shaped.

5. A device according to claim 1,
wherein the receiving vessel is provided in the form of a sphere.

6. A device according to claim 1,
wherein the receiving vessel comprises an outer tube and an inner tube which are arranged inside one another, wherein the receiving chamber is formed between said two tubes, and
that the outer tube constitutes the light incidence wall and the inner tube the activation wall.

7. A device according to claim 1,
wherein the photo sensitizer is provided in the form of a powder.

8. A device according to claim 1,
wherein to permit light to enter the receiving chamber, there is provided a light source which is arranged on that side of the at least one light incidence wall which faces away from the receiving chamber.

9. A device according to claim 1,
wherein the through-flow channel on that side of the transparent wall which faces away from the receiving chamber and which constitutes both the light incidence wall as well as the activation wall is delimited by a transparent channel delimiting wall, and that to permit light to enter the receiving chamber, at least one light source is arranged on that side of the channel delimiting wall which faces away from the receiving chamber.

10. A device according to claim 1,
wherein on that side of the at least one transparent wall which faces away from the receiving chamber and which constitutes both the light incidence wall and the activation wall, the through-flow channel is delimited by a channel delimiting wall into which there is integrated at least one light source to permit light to enter the receiving chamber.
